(19) United States
(12) Patent Application Publication
(10) Pub. No.: US 2024/0346211 A1
(43) Pub. Date: Oct. 17, 2024

(54) MODELING POWER USED IN A MULTI-TENANT PRIVATE CLOUD ENVIRONMENT

(71) Applicant: International Business Machines Corporation, Armonk, NY (US)

(72) Inventors: Sunyanan Choochotkaew, Koto (JP); Tatsuhiro Chiba, Bunkyo-ku (JP); Marcelo Carneiro Do Amaral, Tokyo (JP); Eun Kyung Lee, Bedford Corners, NY (US)

(21) Appl. No.: 18/135,619

(22) Filed: Apr. 17, 2023

(51) Int. Cl. G06F 30/27

(52) U.S. Cl. CPC G06F 30/27; G06F 2111/02

(57) ABSTRACT

Described are techniques for modeling power in the multi-tenant private cloud environment. An absolute power model is trained to estimate the absolute power in the multi-tenant private cloud environment. The absolute power model is composed of both independent and dependent inferences. Furthermore, a dynamic power model is trained to estimate the dynamic power in the multi-tenant private cloud environment based on the deconstructed independent inferences. The dynamic power model is composed of only the deconstructed independent inferences. The absolute power model and the dynamic power model are then combined into a combined model to model the power in the multi-tenant private cloud environment after validating the dynamic power model. The combined model may then be utilized to estimate the power used in the multi-tenant private cloud environment if the error metrics of the combined model indicate that a measured error of the combined model is less than a threshold value.

### TECHNICAL FIELD

The present disclosure relates generally to power modeling, and more particularly to modeling power used in a multi-tenant private cloud environment.

### BACKGROUND

A power model is a mathematical model that is an abstract description of the power utilized by a system using mathematical concepts. For example, a power model may correspond to a mathematical model that is an abstract description of the power utilized, such as by a multi-tenant private cloud environment. A tenant is a group of users who share a common access with specific privileges, such as to a software instance. A private cloud environment is a cloud infrastructure operated solely for a single organization, whether managed internally or by a third party, and hosted either internally or externally. A multi-tenant private cloud environment refers to multiple tenants utilizing the private cloud environment. An example of such a multi-tenant private cloud environment is a multi-tenant container orchestration system (e.g., Kubernetes® cluster).

### SUMMARY

In one embodiment of the present disclosure, a computer-implemented method for modeling power used in a multi-tenant private cloud environment comprises training an absolute power model to estimate absolute power in the multi-tenant private cloud environment. The method further comprises training a dynamic power model to estimate dynamic power in the multi-tenant private cloud environment. The method additionally comprises combining the absolute power model and the dynamic power model into a combined model. Furthermore, the method comprises estimating power used in the multi-tenant private cloud environment using the combined model in response to error metrics of the combined model indicating that a measured error of the combined model is less than a threshold value.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 illustrates the architecture of a container orchestration system in accordance with an embodiment of the present disclosure;

FIG. 3 is a diagram of the software components used by the power modeling mechanism to model the power used in a multi-tenant private cloud environment in accordance with an embodiment of the present disclosure;

FIG. 4 illustrates an embodiment of the present disclosure of the hardware configuration of the power modeling mechanism which is representative of a hardware environment for practicing the present disclosure; and

FIG. 5 is a flowchart of a method for modeling power used in a multi-tenant private cloud environment in accordance with an embodiment of the present disclosure.

### DETAILED DESCRIPTION

As stated above, a power model is a mathematical model that is an abstract description of the power utilized by a system using mathematical concepts. For example, a power model may correspond to a mathematical model that is an abstract description of the power utilized, such as by a multi-tenant private cloud environment. A tenant is a group of users who share a common access with specific privileges, such as to a software instance. A private cloud environment is a cloud infrastructure operated solely for a single organization, whether managed internally or by a third party, and hosted either internally or externally. A multi-tenant private cloud environment refers to multiple tenants utilizing the private cloud environment. An example of such a multi-tenant private cloud environment is a multi-tenant container orchestration system (e.g., Kubernetes® cluster).

In green cloud computing (maximizing energy efficiency while minimizing CO₂ emissions and e-waste), power modeling plays a key role in carbon emission accounting. For example, the amount of power estimated to be consumed by a shared server in the multi-tenant private cloud environment caused by usage of each tenant's workload, usage of the operating and maintaining systems, and idle power may be valuable to know in order to estimate the amount of carbon emissions.

In constructing a power model to estimate such power consumption, the host power for processing the workload on each specific processor architecture in the multi-tenant private cloud environment needs to be characterized. Such characterization may be accomplished, at least in part, by considering the dynamic power as power demanded by the workload due its usage regardless of where the workload is being executed in the multi-tenant private cloud environment. Dynamic power refers to the power dissipated due to the switching activity during charging and discharging of the load capacities. Such dynamic power should be considered independent from the operating environment as well as co-locating processes.

However, it is difficult to deconstruct and model the dynamic power. For example, modeling the dynamic power currently relies on using the difference of power before and after running the target workload, which requires a strictly controlled environment, which is not a trivial matter in some environments, such as in a multi-tenant private cloud environment (e.g., Kubernetes® cluster).

As a result, there is not currently a means for effectively modeling power in a multi-tenant private cloud environment (e.g., Kubernetes® cluster), such as by modeling, at least in part, the dynamic power.

The embodiments of the present disclosure provide a means for modeling power used in a multi-tenant private cloud environment by training an absolute power model to estimate the absolute power in the multi-tenant private cloud environment. Absolute power, as used herein, refers to the total power dissipated in the multi-tenant private cloud environment. In one embodiment, the absolute power model is composed of both independent and dependent inferences. An independent inference, as used herein, refers to the cause of energy consumption corresponding to the workload utilization regardless of the environment, hardware and operating system. A dependent inference, as used herein, refers to the causes of energy consumption other than the independence inferences. Since power consumed by any workload is composed of dependent and independent inferences, power can be modeled by deconstructing the power by the energy consumption inferring causes. In one embodiment, such independent inferences of the absolute power model are deconstructed by removing a target (e.g., target application) workload utilization. A dynamic power model may then be trained to estimate the dynamic power in the multi-tenant private cloud environment, where the model includes only the deconstructed independent inferences. Dynamic power, as used herein, refers to the power dissipated due to the switching activity during charging and discharging of the load capacities. After validating the dynamic power model, such as by reconstructing the dynamic workload with the dependent inferences, the absolute power model and the dynamic power model are combined to form a combined model. Such a combined model may be used to estimate the power used in a multi-tenant private cloud environment, such as estimating the power used by the pods in a container orchestration system. In this manner, power may be more effectively modeled in a multi-tenant private cloud environment (e.g., Kubernetes® cluster) due to deconstructing the power by its energy consumption inferring causes. A further discussion regarding these and other features is provided below.

In some embodiments of the present disclosure, the present disclosure comprises a computer-implemented method, system and computer program product for modeling power in the multi-tenant private cloud environment. In one embodiment of the present disclosure, an absolute power model is trained to estimate the absolute power in the multi-tenant private cloud environment (e.g., Kubernetes® cluster). Absolute power, as used herein, refers to the total power dissipated in the multi-tenant private cloud environment. In one embodiment, the absolute power model is composed of both independent and dependent inferences. An independent inference, as used herein, refers to the cause of energy consumption corresponding to the workload utilization regardless of the environment, hardware and operating system. Examples of independent inferences include, but not limited to, idling time (e.g., idling time of processor), workload distribution, algorithm class, execution time, etc. A dependent inference, as used herein, refers to the causes of energy consumption other than the independence inferences. Examples of dependent inferences, include, but not limited to, type of CPU, CPU frequency, type of video card, number of drives, peripherals, etc. Since power consumed by any workload is composed of dependent and independent inferences, power can be modeled by deconstructing the power by the energy consumption inferring causes. Furthermore, a dynamic power model is trained to estimate the dynamic power in the multi-tenant private cloud environment based on the deconstructed independent inferences. Dynamic power, as used herein, refers to the power dissipated due to the switching activity during charging and discharging of the load capacities. In one embodiment, the dynamic power model is composed of only the deconstructed independent inferences. The absolute power model and the dynamic power model are then combined into a combined model to model the power in the multi-tenant private cloud environment after validating the dynamic power model. Using error metrics of the combined model to determine the goodness (“goodness of fit”) of the combined model, the combined model may then be utilized to estimate the power used in the multi-tenant private cloud environment if the error metrics of the combined model indicate that a measured error of the combined model is less than a threshold value. In this manner, power may be more effectively modeled in a multi-tenant private cloud environment (e.g., Kubernetes® cluster) due to deconstructing the power by its energy consumption inferring causes.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

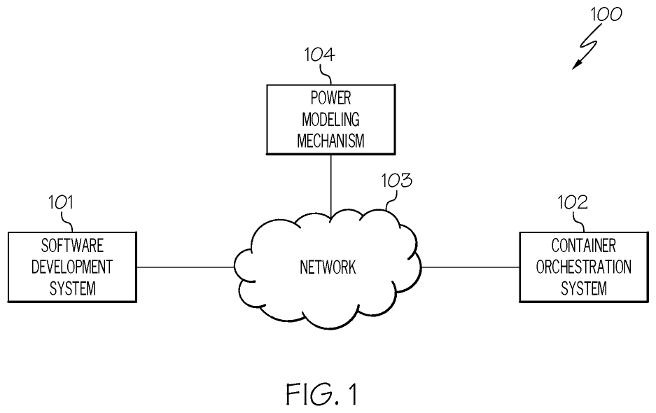

Referring now to the Figures in detail, FIG. 1 illustrates an embodiment of the present disclosure of a communication system 100 for practicing the principles of the present disclosure. Communication system 100 includes a software development system 101 connected to a container orchestration system 102 via a network 103.

Software development system 101 is a system utilized, such as by software developers, in the process of creating, designing, deploying, and supporting software. Examples of such software development systems include, but not limited to, RAD Studio®, Embold®, Collaborator®, Studio 3T®, NetBeans®, Zend Studio®, Microsoft® Expression Studio, etc.

In one embodiment, software development system 101 is utilized by a software developer to deploy, manage, scale and network containers using container orchestration system 102 (e.g., Kubernetes®, Apache® Mesos, Amazon ECS®) via network 103.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, container orchestration system 102 automates the deployment, management, scaling, and networking of containers. A “container,” as used herein, refers to a standard unit of software that packages up code and all its dependencies so that the application runs quickly and reliably from one computing environment to another.

In one embodiment, container orchestration system 102 corresponds to a multi-tenant container orchestration system (e.g., Kubernetes® cluster). A tenant, as used herein, refers to a group of users who share a common access with specific privileges, such as to a software instance. A multi-tenant container orchestration system, as used herein, refers to multiple tenants utilizing the container orchestrating system, such as container orchestration system 102.

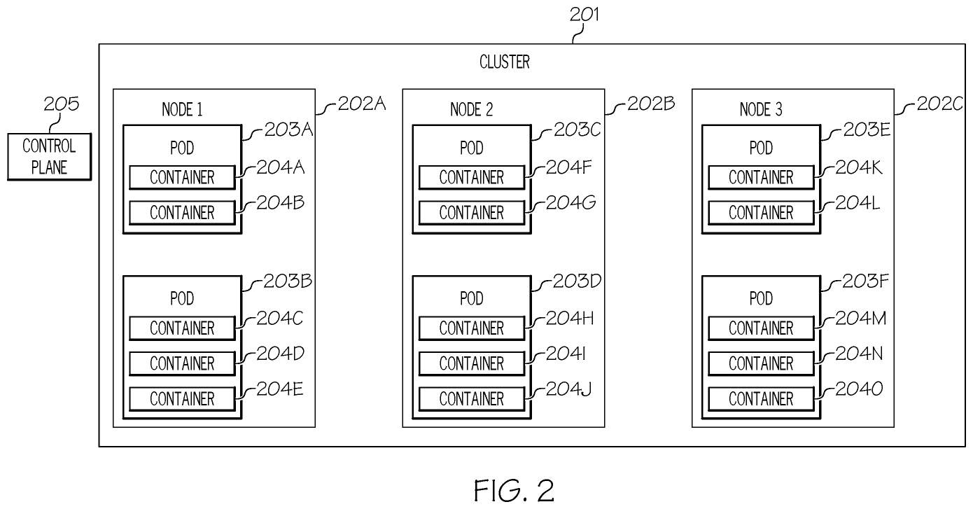

A further description of the architecture of container orchestration system 102 is provided below in connection with FIG. 2.

Additionally, as shown in FIG. 1, system 100 includes a power modeling mechanism 104 connected to network 103. In one embodiment, power modeling mechanism 104 is configured to model the power used in a multi-tenant private cloud environment. In one embodiment, such an environment corresponds to a multi-tenant container orchestration system, such as container orchestration system 102.

In one embodiment, power modeling mechanism 104 models power used in a multi-tenant private cloud environment, such as container orchestration system 102, by training an absolute power model to estimate the absolute power in the multi-tenant private cloud environment. Absolute power, as used herein, refers to the total power dissipated in the multi-tenant private cloud environment. In one embodiment, the absolute power model is composed of both independent and dependent inferences. An independent inference, as used herein, refers to the cause of energy consumption corresponding to the workload utilization regardless of the environment, hardware and operating system. A dependent inference, as used herein, refers to the causes of energy consumption other than the independence inferences. Since power consumed by any workload is composed of dependent and independent inferences, power can be modeled by deconstructing the power by the energy consumption inferring causes.

In one embodiment, power modeling mechanism 104 deconstructs such independent inferences of the absolute power model by removing a target (e.g., target application) workload utilization. In one embodiment, power modeling mechanism 104 trains a dynamic power model to estimate the dynamic power in the multi-tenant private cloud environment, where the model includes only the deconstructed independent inferences. Dynamic power, as used herein, refers to the power dissipated due to the switching activity during charging and discharging of the load capacities.

After validating the dynamic power model, such as by reconstructing the dynamic workload with the dependent inferences, in one embodiment, power modeling mechanism 104 combines the absolute power model and the dynamic power model to form a combined model. Such a combined model may be used to estimate the power used in a multi-tenant private cloud environment, such as estimating the power used by the pods in a container orchestration system (e.g., container orchestration system 102). In this manner, power may be more effectively modeled in a multi-tenant private cloud environment (e.g., Kubernetes® cluster of container orchestration system 102) due to deconstructing the power by its energy consumption inferring causes. A further discussion regarding these and other features is provided below.

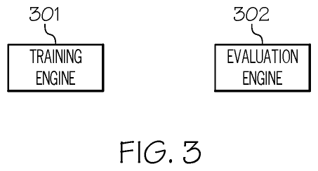

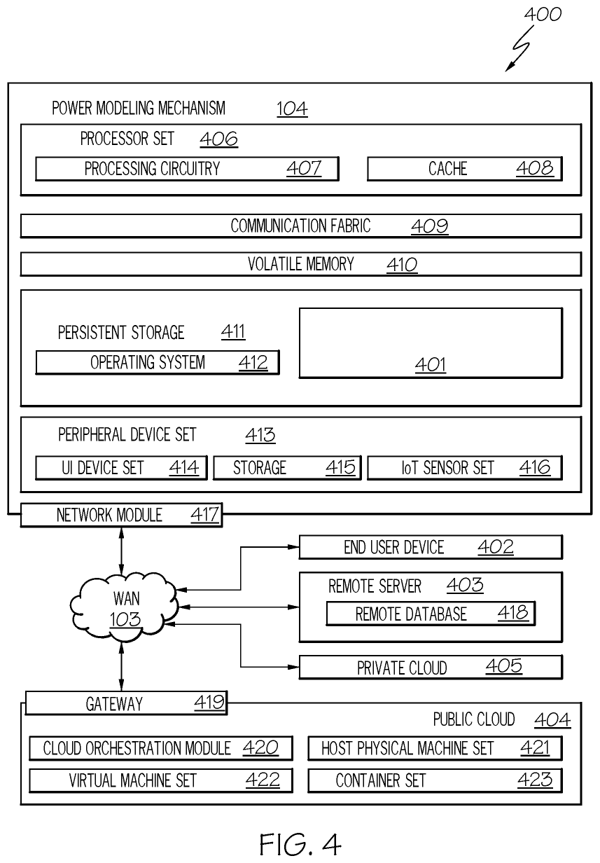

A description of the software components of power modeling mechanism 104 used for modeling power used in a multi-tenant private cloud environment, such as container orchestration system 102, is provided below in connection with FIG. 3. A description of the hardware configuration of power modeling mechanism 104 is provided further below in connection with FIG. 4.

System 100 is not to be limited in scope to any one particular network architecture. System 100 may include any number of software development systems 101, container orchestration systems 102, networks 103 and power modeling mechanisms 104.

As previously discussed, a description of the architecture of container orchestration system 102 is provided below in connection with FIG. 2.

Referring to FIG. 2, FIG. 2 illustrates the architecture of container orchestration system 102 (FIG. 1) in accordance with an embodiment of the present disclosure.

As shown in FIG. 2, container orchestration system 102 includes a cluster 201 (e.g., Kubernetes® cluster) consisting of a set of worker machines, referred to herein as nodes 202A-202C (identified as “Node 1,” “Node 2,” and “Node 3,” respectively in FIG. 2), that run containerized applications. Nodes 202A-202C may collectively or individually be referred to as nodes 201 or node 201, respectively. While FIG. 2 illustrates three nodes 202, a cluster 201 of container orchestration system 102 may include any number of nodes 202.

In one embodiment, nodes 202 host the pods that are the components of the application workload. For example, as shown in FIG. 2, node 202A hosts pods 203A-203B. Node 202B hosts pods 203C-203D and node 202C hosts pods 203E-203F. Pods 203A-203F may collectively or individually be referred to as pods 203 or pod 203, respectively. It is noted that each node 202 may host any number of pods 203 and that FIG. 2 is used for illustration purposes. A pod 203, as used herein, refers to the smallest deployable unit of computing that can be created and managed in container orchestration system 102 (e.g., Kubernetes®). Furthermore, a pod 203, as used herein, encapsulates a group of one or more containers, which shared storage and network resources, and a specification for how to run the containers. In one embodiment, the contents of pod 203 are co-located and co-scheduled and run in a shared context. In one embodiment, pod 203 models an application-specific “logical host,” where pod 203 contains one or more application containers which are relatively tightly coupled.

For example, pod 203A encapsulates the group of containers 204A-204B. Pod 203B encapsulates the group of containers 204C-204E. Pod 203C encapsulates the group of containers 204F-204G. Pod 203D encapsulates the group of containers 204H-204J. Pod 203E encapsulates the group of containers 204K-204L. Pod 203F encapsulates the group of containers 204M-2040. Containers 204A-2040 may collectively or individually be referred to as containers 204 or container 204, respectively. All the containers, such as containers 204A-204B in pod 203A, share an Internet Protocol (IP) address, inter-process communication (IPC), hostname and other resources. While FIG. 2 illustrates a particular number of containers 204 being encapsulated in pod 203, it is noted that pod 203 may encapsulate any number of containers 204.

Furthermore, as shown in FIG. 2, container orchestration system 102 includes a control plane 205 configured to manage nodes 202 and pods 203 in cluster 201. In one embodiment, in production environments, control plane 205 runs across multiple computers providing fault-tolerance and high availability. Furthermore, in one embodiment, control plane 205 coordinates the behavior of proxies and provides APIs for operations and maintenance.

A discussion regarding the software components used by power modeling mechanism 104 to model the power used in a multi-tenant private cloud environment (e.g., Kubernetes® cluster) is provided below in connection with FIG. 3.

FIG. 3 is a diagram of the software components used by power modeling mechanism 104 (FIG. 1) to model the power used in a multi-tenant private cloud environment (e.g., Kubernetes® cluster) in accordance with an embodiment of the present disclosure.

As shown in FIG. 3, power modeling mechanism 104 includes a training engine 301 configured to train an absolute power model to estimate the absolute power in a multi-tenant private cloud environment (e.g., cluster 201). Absolute power, as used herein, refers to the total power dissipated in the multi-tenant private cloud environment. In one embodiment, the absolute power model is composed of both independent and dependent inferences. An independent inference, as used herein, refers to the cause of energy consumption corresponding to the workload utilization regardless of the environment, hardware and operating system. Examples of independent inferences include, but not limited to, idling time (e.g., idling time of processor), workload distribution, algorithm class, execution time, etc. A dependent inference, as used herein, refers to the causes of energy consumption other than the independence inferences. Examples of dependent inferences, include, but not limited to, type of CPU, CPU frequency, type of video card, number of drives, peripherals, etc. Since power consumed by any workload is composed of dependent and independent inferences, power can be modeled by deconstructing the power by the energy consumption inferring causes.

In one embodiment, training engine 301 uses a machine learning algorithm to build and train a model (“absolute power model”) to estimate the absolute power in a multi-tenant private cloud environment (e.g., cluster 201) based on the independent and dependent inferences (absolute power model includes both dependent and independent inferences). As discussed above, absolute power refers to the total power dissipated in the multi-tenant private cloud environment. In one embodiment, such a model (absolute power model) is built and trained using a sample data set that includes the amount of absolute power in a multi-tenant private cloud environment (e.g., cluster 201) based on the independent and dependent inferences (e.g., workload distribution, algorithm class, execution time, type of CPU, type of video card, number of drives, etc.). For example, such a sample data set may include various estimates for the absolute power based on various data points for the independent and dependent inferences (e.g., different execution times, different algorithm classes, different workload distributions, etc.). In one embodiment, such a sample data set is compiled by an expert.

Furthermore, such a sample data set is referred to herein as the “training data,” which is used by the machine learning algorithm to make predictions or decisions as to the estimated absolute power in a multi-tenant private cloud environment (e.g., cluster 201) based on the independent and dependent inferences. The algorithm iteratively makes predictions of the estimated absolute power in a multi-tenant private cloud environment (e.g., cluster 201) until the predictions achieve the desired accuracy as determined by an expert. Examples of such learning algorithms include nearest neighbor, Naïve Bayes, decision trees, linear regression, support vector machines and neural networks.

In one embodiment, the training of the absolute power model is represented mathematically as shown below:

Train P̅=Abs(U,f) with P,

where P̅ is the predicted power used per package, Abs is the absolute power model, U is the resource usage (example of independent inference), f is the CPU frequency (example of dependent inference) and P is power.

In one embodiment, the error (mean absolute error) (ε_{abs}) of the absolute power model is represented mathematically as shown below:

ε_{abs}=error(P,P̅)

In one embodiment, training engine 301 is further configured to deconstruct the independent inferences of the absolute power model by removing the target (i.e., the target workload) utilization (U(xᵢ)). Such a deconstruction may be represented mathematically as shown below:

$$Δ {\overline{P}}_{x i} = P - Abs ( U - U ( {x}_{i} ) , f ) ,$$

where ΔP̅ₓᵢ is the estimate power per package used by the target application (app) xᵢ using the absolute power model, x={x₁, x₂, . . . } correspond to the target applications, and U(xᵢ) is the resource usage by the target workload xᵢ.

In one embodiment, (ρ), the correlation of the usage to the dynamic power after removing the training state dependent power, may be expressed mathematically as shown below:

ρ=Corr(U(xᵢ),ΔP̅ₓᵢ)

In one embodiment, training engine 301 trains the dynamic power model to estimate the dynamic power in the multi-tenant private cloud environment (e.g., cluster 201) based on the deconstructed independent inferences (dynamic power model includes only the deconstructed independent inferences). Dynamic power, as used herein, refers to the power dissipated due to the switching activity during charging and discharging of the load capacities. In one embodiment, the dynamic power model is composed of only the deconstructed independent inferences.

In one embodiment, training engine 301 uses a machine learning algorithm to build and train a model (“dynamic power model”) to estimate the dynamic power in a multi-tenant private cloud environment (e.g., cluster 201) based on the deconstructed independent inferences. As discussed above, dynamic power refers to the power dissipated due to the switching activity during charging and discharging of the load capacities. In one embodiment, such a model (dynamic power model) is built and trained using a sample data set that includes the amount of dynamic power in a multi-tenant private cloud environment (e.g., cluster 201) based on such deconstructed independent inferences (e.g., workload distribution, algorithm class, execution time). For example, such a sample data set may include various estimates for the dynamic power based on various data points for the deconstructed independent inferences (e.g., different workload distributions, etc.). In one embodiment, such a sample data set is compiled by an expert.

Furthermore, such a sample data set is referred to herein as the “training data,” which is used by the machine learning algorithm to make predictions or decisions as to the estimated dynamic power in a multi-tenant private cloud environment (e.g., cluster 201) based on the deconstructed independent inferences. The algorithm iteratively makes predictions of the estimated dynamic power in a multi-tenant private cloud environment (e.g., cluster 201) until the predictions achieve the desired accuracy as determined by an expert. Examples of such learning algorithms include nearest neighbor, Naïve Bayes, decision trees, linear regression, support vector machines and neural networks.

In one embodiment, the training of the dynamic power model is represented mathematically as shown below:

Train ΔP̅=Dyn(Uₓ) with ΔP̅ₓ.

where ΔP̅ is the predicted training state independent power per page, Dyn is the dynamic power model, Uₓ is the concatenated U (xᵢ) and ΔP̅ₓ is the concatenated ΔP̅ₓᵢ.

In one embodiment, the error (mean absolute error) (ε_{dyn}) of the dynamic power model is represented mathematically as shown below:

ε_{dyn}=error(ΔP̅ₓ,ΔP̅)

Power modeling mechanism 104 further includes an evaluation engine 302 configured to perform various types of evaluations and measurements, including validating the dynamic power model by reconstructing the dynamic workload with dependent inferences (e.g., CPU frequency). Such validation may be represented mathematically as shown below:

$$\overline{\overline{P}} = Abs ( U - U ( {x}_{i} ) , f ) + \sum Dyn ( U ( x i ) )$$

In one embodiment, the error (mean absolute error) in the reconstruction of the dynamic workload may be represented mathematically as shown below (corresponds to the same formula for the error of the absolute power model):

ε_{reconstruct}=error(P,P̅)

Evaluation engine 302 is further configured to combine the absolute power model and the dynamic power model into a combined model to model the power in the multi-tenant private cloud environment. For example, the modeling of P=Abs (U−ΣX,f)+ΣDyn (X).

By modeling the power in this manner, the controlled environment is eliminated. Furthermore, an accelerated training state (training state directed to idle data collection) is eliminated by modeling the power in this manner. Instead, the estimated inferred power is obtained from the dynamic power (ΣDyn(X)).

Evaluation engine 302 is additionally configured to determine the goodness (goodness-of-fit) of the combined model by using the error metrics (e.g., ε_{dyn}) of the dynamic power model together with the correction and error metrics (e.g., ε_{reconstruct}) of the absolute power model. That is, evaluation engine 302 of power modeling mechanism 104 uses the error metrics of the dynamic power model together with the correction and error metrics of the absolute power model to determine the measured error of the combined model. In one embodiment, such determined goodness may be represented mathematically as shown below:

ε̅: mean(ε_{dyn},ε_{reconstruct}),

where ε̅ corresponds to the mean of the errors ε_{dyn} and ε_{reconstruct}.

In one embodiment, if the measured error (e.g., ε̅) of the combined model is less than a threshold value, then evaluation engine 302 proceeds with estimating the power used in the multi-tenant private cloud environment using the combined model, such as estimating the power used by pods 203 in container orchestration system 102 on a virtual private cloud environment. Examples of such a virtual private cloud environment, include, but not limited to, IKS (IBM® Cloud Kubernetes® Service), ROKS (RedHat® OpenShift Kubernetes® Service), EKS (Amazon® Elastic Container Service for Kubernetes®), AKS (Azure® Kubernetes® Service), etc. where the physical hardware is unrevealed.

By now being able to effectively model power in a multi-tenant private cloud environment, including modeling the dynamic power, carbon emission accounting can be more accurately measured and validated.

A further description of these and other features is provided below in connection with the discussion of the method for modeling power used in a multi-tenant private cloud environment.

Prior to the discussion of the method for modeling power used in a multi-tenant private cloud environment, a description of the hardware configuration of power modeling mechanism 104 (FIG. 1) is provided below in connection with FIG. 4.

Referring now to FIG. 4, in conjunction with FIG. 1, FIG. 4 illustrates an embodiment of the present disclosure of the hardware configuration of power modeling mechanism 104 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code (computer code for modeling power used in a multi-tenant private cloud environment stored in block 401) involved in performing the disclosed methods, such as modeling power used in a multi-tenant private cloud environment. In addition to block 401, computing environment 400 includes, for example, power modeling mechanism 104, network 103, such as a wide area network (WAN), end user device (EUD) 402, remote server 403, public cloud 404, and private cloud 405. In this embodiment, power modeling mechanism 104 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Power modeling mechanism 104 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically power modeling mechanism 104, to keep the presentation as simple as possible. Power modeling mechanism 104 may be located in a cloud, even though it is not shown in a cloud in FIG. 4. On the other hand, power modeling mechanism 104 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto power modeling mechanism 104 to cause a series of operational steps to be performed by processor set 406 of power modeling mechanism 104 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 408 and the other storage media discussed below. The program instructions, and associated data, are accessed by processor set 406 to control and direct performance of the disclosed methods. In computing environment 400, at least some of the instructions for performing the disclosed methods may be stored in block 401 in persistent storage 411.

Communication fabric 409 is the signal conduction paths that allow the various components of power modeling mechanism 104 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In power modeling mechanism 104, the volatile memory 410 is located in a single package and is internal to power modeling mechanism 104, but, alternatively or additionally, the volatile memory may be distributed over multiple packages and/or located externally with respect to power modeling mechanism 104.

Persistent Storage 411 is any form of non-volatile storage for computers that is now known or to be developed in the future. The non-volatility of this storage means that the stored data is maintained regardless of whether power is being supplied to power modeling mechanism 104 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the disclosed methods.

Peripheral device set 413 includes the set of peripheral devices of power modeling mechanism 104. Data communication connections between the peripheral devices and the other components of power modeling mechanism 104 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where power modeling mechanism 104 is required to have a large amount of storage (for example, where power modeling mechanism 104 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows power modeling mechanism 104 to communicate with other computers through WAN 103. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the disclosed methods can typically be downloaded to power modeling mechanism 104 from an external computer or external storage device through a network adapter card or network interface included in network module 417.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates power modeling mechanism 104), and may take any of the forms discussed above in connection with power modeling mechanism 104. EUD 402 typically receives helpful and useful data from the operations of power modeling mechanism 104. For example, in a hypothetical case where power modeling mechanism 104 is designed to provide a recommendation to an end user, this recommendation would typically be communicated from network module 417 of power modeling mechanism 104 through WAN 103 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to power modeling mechanism 104. Remote server 403 may be controlled and used by the same entity that operates power modeling mechanism 104. Remote server 403 represents the machine(s) that collect and store helpful and useful data for use by other computers, such as power modeling mechanism 104. For example, in a hypothetical case where power modeling mechanism 104 is designed and programmed to provide a recommendation based on historical data, then this historical data may be provided to power modeling mechanism 104 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIG. 3 to model power used in a multi-tenant private cloud environment. In one embodiment, such components may be implemented in hardware. The functions discussed above performed by such components are not generic computer functions. As a result, power modeling mechanism 104 is a particular machine that is the result of implementing specific, non-generic computer functions.

In one embodiment, the functionality of such software components of power modeling mechanism 104, including the functionality for modeling power used in a multi-tenant private cloud environment, may be embodied in an application specific integrated circuit.

As stated above, in green cloud computing (maximizing energy efficiency while minimizing CO₂ emissions and e-waste), power modeling plays a key role in carbon emission accounting. For example, the amount of power estimated to be consumed by a shared server in the multi-tenant private cloud environment caused by usage of each tenant's workload, usage of the operating and maintaining systems, and idle power may be valuable to know in order to estimate the amount of carbon emissions. In constructing a power model to estimate such power consumption, the host power for processing the workload on each specific processor architecture in the multi-tenant private cloud environment needs to be characterized. Such characterization may be accomplished, at least in part, by considering the dynamic power as power demanded by the workload due its usage regardless of where the workload is being executed in the multi-tenant private cloud environment. Dynamic power refers to the power dissipated due to the switching activity during charging and discharging of the load capacities. Such dynamic power should be considered independent from the operating environment as well as co-locating processes. However, it is difficult to deconstruct and model the dynamic power. For example, modeling the dynamic power currently relies on using the difference of power before and after running the target workload, which requires a strictly controlled environment, which is not a trivial matter in some environments, such as in a multi-tenant private cloud environment (e.g., Kubernetes® cluster). As a result, there is not currently a means for effectively modeling power in a multi-tenant private cloud environment (e.g., Kubernetes® cluster), such as by modeling, at least in part, the dynamic power.

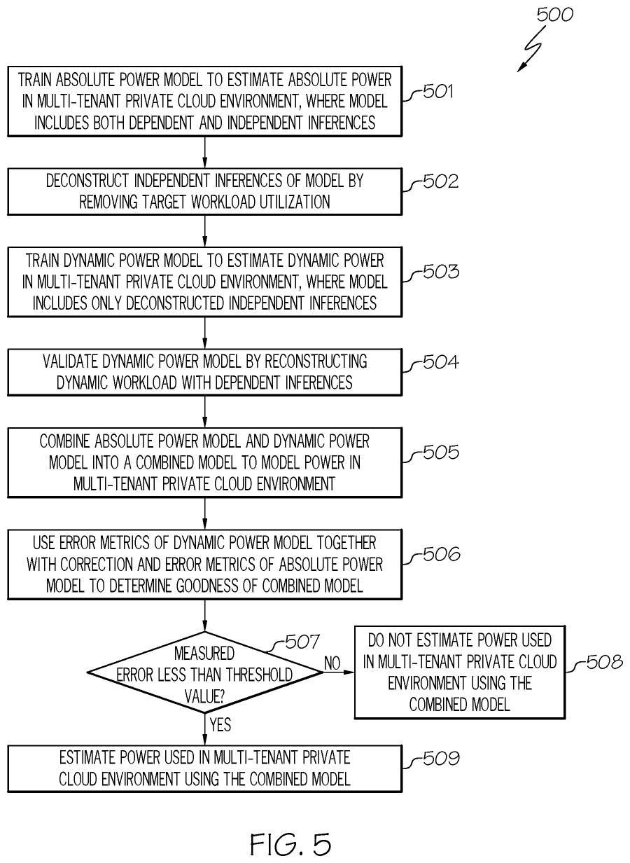

The embodiments of the present disclosure provide a means for effectively modeling power used in a multi-tenant private cloud environment (e.g., Kubernetes® cluster) as discussed below in connection with FIG. 5.

FIG. 5 is a flowchart of a method 500 for modeling power used in a multi-tenant private cloud environment (e.g., Kubernetes® cluster) in accordance with an embodiment of the present disclosure.

Referring to FIG. 5, in conjunction with FIGS. 1-4, in operation 501, training engine 301 of power modeling mechanism 104 trains an absolute power model to estimate the absolute power in a multi-tenant private cloud environment (e.g., cluster 201).

As discussed above, absolute power, as used herein, refers to the total power dissipated in the multi-tenant private cloud environment. In one embodiment, the absolute power model is composed of both independent and dependent inferences. An independent inference, as used herein, refers to the cause of energy consumption corresponding to the workload utilization regardless of the environment, hardware and operating system. Examples of independent inferences include, but not limited to, idling time (e.g., idling time of processor), workload distribution, algorithm class, execution time, etc. A dependent inference, as used herein, refers to the causes of energy consumption other than the independence inferences. Examples of dependent inferences, include, but not limited to, type of CPU, CPU frequency, type of video card, number of drives, peripherals, etc. Since power consumed by any workload is composed of dependent and independent inferences, power can be modeled by deconstructing the power by the energy consumption inferring causes.

In one embodiment, training engine 301 uses a machine learning algorithm to build and train a model (“absolute power model”) to estimate the absolute power in a multi-tenant private cloud environment (e.g., cluster 201) based on the independent and dependent inferences (absolute power model includes both dependent and independent inferences). As discussed above, absolute power refers to the total power dissipated in the multi-tenant private cloud environment. In one embodiment, such a model (absolute power model) is built and trained using a sample data set that includes the amount of absolute power in a multi-tenant private cloud environment (e.g., cluster 201) based on the independent and dependent inferences (e.g., workload distribution, algorithm class, execution time, type of CPU, type of video card, number of drives, etc.). For example, such a sample data set may include various estimates for the absolute power based on various data points for the independent and dependent inferences (e.g., different execution times, different algorithm classes, different workload distributions, etc.). In one embodiment, such a sample data set is compiled by an expert.

Furthermore, such a sample data set is referred to herein as the “training data,” which is used by the machine learning algorithm to make predictions or decisions as to the estimated absolute power in a multi-tenant private cloud environment (e.g., cluster 201) based on the independent and dependent inferences. The algorithm iteratively makes predictions of the estimated absolute power in a multi-tenant private cloud environment (e.g., cluster 201) until the predictions achieve the desired accuracy as determined by an expert. Examples of such learning algorithms include nearest neighbor, Naïve Bayes, decision trees, linear regression, support vector machines and neural networks.

In one embodiment, the training of the absolute power model is represented mathematically as shown below:

Train P̅=Abs(U,f) with P,

where P̅ is the predicted power used per package, Abs is the absolute power model, U is the resource usage (example of independent inference), f is the CPU frequency (example of dependent inference) and P is power.

In one embodiment, the error (mean absolute error) (ε_{abs}) of the absolute power model is represented mathematically as shown below:

ε_{abs}=error(P,P̅)

In operation 502, training engine 301 of power modeling mechanism 104 deconstructs the independent inferences of the absolute power model by removing the target (i.e., the target workload) utilization (U(xᵢ)). Such a deconstruction may be represented mathematically as shown below:

$$Δ {\overline{P}}_{x i} = P - Abs ( U - U ( {x}_{i} ) , f ) ,$$

where ΔP̅ₓᵢ is the estimate power per package used by the target application (app) xᵢ using the absolute power model, x={x₁, x₂, . . . } correspond to the target applications, and U (xᵢ) is the resource usage by the target workload xᵢ.

As stated above, in one embodiment, (ρ), the correlation of the usage to the dynamic power after removing the training state dependent power, may be expressed mathematically as shown below:

ρ=Corr(U(xᵢ),ΔP̅ₓᵢ)

In operation 503, training engine 301 of power modeling mechanism 104 trains the dynamic power model to estimate the dynamic power in the multi-tenant private cloud environment (e.g., cluster 201) based on the deconstructed independent inferences (dynamic power model includes only the deconstructed independent inferences). Dynamic power, as used herein, refers to the power dissipated due to the switching activity during charging and discharging of the load capacities. In one embodiment, the dynamic power model is composed of only the deconstructed independent inferences.

As discussed above, in one embodiment, training engine 301 uses a machine learning algorithm to build and train a model (“dynamic power model”) to estimate the dynamic power in a multi-tenant private cloud environment (e.g., cluster 201) based on the deconstructed independent inferences. As discussed above, dynamic power refers to the power dissipated due to the switching activity during charging and discharging of the load capacities. In one embodiment, such a model (dynamic power model) is built and trained using a sample data set that includes the amount of dynamic power in a multi-tenant private cloud environment (e.g., cluster 201) based on such deconstructed independent inferences (e.g., workload distribution, algorithm class, execution time). For example, such a sample data set may include various estimates for the dynamic power based on various data points for the deconstructed independent inferences (e.g., different workload distributions, etc.). In one embodiment, such a sample data set is compiled by an expert.

Furthermore, such a sample data set is referred to herein as the “training data,” which is used by the machine learning algorithm to make predictions or decisions as to the estimated dynamic power in a multi-tenant private cloud environment (e.g., cluster 201) based on the deconstructed independent inferences. The algorithm iteratively makes predictions of the estimated dynamic power in a multi-tenant private cloud environment (e.g., cluster 201) until the predictions achieve the desired accuracy as determined by an expert. Examples of such learning algorithms include nearest neighbor, Naïve Bayes, decision trees, linear regression, support vector machines and neural networks.

In one embodiment, the training of the dynamic power model is represented mathematically as shown below:

Train ΔP̅=Dyn(Uₓ) with ΔP̅ₓ.

where ΔP̅ is the predicted training state independent power per page, Dyn is the dynamic power model, Uₓ is the concatenated U (xᵢ) and ΔP̅ₓ is the concatenated ΔP̅ₓᵢ.

In one embodiment, the error (mean absolute error) (ε_{dyn}) of the dynamic power model is represented mathematically as shown below:

ε_{dyn}=error(ΔP̅ₓ,ΔP̅)

In operation 504, evaluation engine 302 of power modeling mechanism 104 validates the dynamic power model by reconstructing the dynamic workload with dependent inferences (e.g., CPU frequency). Such validation may be represented mathematically as shown below:

$$\overline{\overline{P}} = Abs ( U - U ( {x}_{i} ) , f ) + \sum Dyn ( U ( x i ) )$$

As stated above, in one embodiment, the error (mean absolute error) in the reconstruction of the dynamic workload may be represented mathematically as shown below (corresponds to the same formula for the error of the absolute power model):

ε_{reconstuct}=error(P,P̅)

In operation 505, evaluation engine 302 of power modeling mechanism 104 combines the absolute power model and the dynamic power model into a combined model to model the power in the multi-tenant private cloud environment. For example, the modeling of P=Abs (U−ΣX,f)+ΣDyn (X).

By modeling the power in this manner, the controlled environment is eliminated. Furthermore, an accelerated training state (training state directed to idle data collection) is eliminated by modeling the power in this manner. Instead, the estimated inferred power is obtained from the dynamic power (ΣDyn (X)).

In operation 506, evaluation engine 302 of power modeling mechanism 104 uses the error metrics (e.g., ε_{dyn}) of the dynamic power model together with the correction and error metrics (e.g., ε_{reconstruct}) of the absolute power model to determine the goodness (goodness-of-fit) of the combined model. That is, evaluation engine 302 of power modeling mechanism 104 uses the error metrics of the dynamic power model together with the correction and error metrics of the absolute power model to determine the measured error of the combined model.

In one embodiment, such determined goodness may be represented mathematically as shown below:

ε̅: mean(ε_{dyn},ε_{reconstruct}),

where ε̅ corresponds to the mean of the errors ε_{dyn} and ε_{reconstruct}.

In operation 507, evaluation engine 302 of power modeling mechanism 104 determines if the measured error (e.g., ε̅) of the combined model is less than a threshold value, which may be user-designated.

If the measured error of the combined model is not less than the threshold value, then, in operation 508, evaluation engine 302 of power modeling mechanism 104 does not proceed with estimating the power used in the multi-tenant private cloud environment using the combined model.

If, however, the measured error of the combined model is less than the threshold value, then, in operation 509, evaluation engine 302 of power modeling mechanism 104 proceeds with estimating the power used in the multi-tenant private cloud environment using the combined model, such as estimating the power used by pods 203 in container orchestration system 102 on a virtual private cloud environment. Examples of such a virtual private cloud environment, include, but not limited to, IKS (IBM® Cloud Kubernetes® Service), ROKS (RedHat® OpenShift Kubernetes® Service), EKS (Amazon® Elastic Container Service for Kubernetes®), AKS (Azure® Kubernetes® Service), etc. where the physical hardware is unrevealed.

By now being able to effectively model power in a multi-tenant private cloud environment, including modeling the dynamic power, carbon emission accounting can be more accurately measured and validated.

Furthermore, the principles of the present disclosure improve the technology or technical field involving power modeling. As discussed above, in green cloud computing (maximizing energy efficiency while minimizing CO₂ emissions and e-waste), power modeling plays a key role in carbon emission accounting. For example, the amount of power estimated to be consumed by a shared server in the multi-tenant private cloud environment caused by usage of each tenant's workload, usage of the operating and maintaining systems, and idle power may be valuable to know in order to estimate the amount of carbon emissions. In constructing a power model to estimate such power consumption, the host power for processing the workload on each specific processor architecture in the multi-tenant private cloud environment needs to be characterized. Such characterization may be accomplished, at least in part, by considering the dynamic power as power demanded by the workload due its usage regardless of where the workload is being executed in the multi-tenant private cloud environment. Dynamic power refers to the power dissipated due to the switching activity during charging and discharging of the load capacities. Such dynamic power should be considered independent from the operating environment as well as co-locating processes. However, it is difficult to deconstruct and model the dynamic power. For example, modeling the dynamic power currently relies on using the difference of power before and after running the target workload, which requires a strictly controlled environment, which is not a trivial matter in some environments, such as in a multi-tenant private cloud environment (e.g., Kubernetes® cluster). As a result, there is not currently a means for effectively modeling power in a multi-tenant private cloud environment (e.g., Kubernetes® cluster), such as by modeling, at least in part, the dynamic power.

Embodiments of the present disclosure improve such technology by training an absolute power model to estimate the absolute power in the multi-tenant private cloud environment (e.g., Kubernetes® cluster). Absolute power, as used herein, refers to the total power dissipated in the multi-tenant private cloud environment. In one embodiment, the absolute power model is composed of both independent and dependent inferences. An independent inference, as used herein, refers to the cause of energy consumption corresponding to the workload utilization regardless of the environment, hardware and operating system. Examples of independent inferences include, but not limited to, idling time (e.g., idling time of processor), workload distribution, algorithm class, execution time, etc. A dependent inference, as used herein, refers to the causes of energy consumption other than the independence inferences. Examples of dependent inferences, include, but not limited to, type of CPU, CPU frequency, type of video card, number of drives, peripherals, etc. Since power consumed by any workload is composed of dependent and independent inferences, power can be modeled by deconstructing the power by the energy consumption inferring causes. Furthermore, a dynamic power model is trained to estimate the dynamic power in the multi-tenant private cloud environment based on the deconstructed independent inferences. Dynamic power, as used herein, refers to the power dissipated due to the switching activity during charging and discharging of the load capacities. In one embodiment, the dynamic power model is composed of only the deconstructed independent inferences. The absolute power model and the dynamic power model are then combined into a combined model to model the power in the multi-tenant private cloud environment after validating the dynamic power model. Using error metrics of the combined model to determine the goodness (“goodness of fit”) of the combined model, the combined model may then be utilized to estimate the power used in the multi-tenant private cloud environment if the error metrics of the combined model indicate that a measured error of the combined model is less than a threshold value. In this manner, power may be more effectively modeled in a multi-tenant private cloud environment (e.g., Kubernetes® cluster) due to deconstructing the power by its energy consumption inferring causes. Furthermore, in this manner, there is an improvement in the technical field involving power modeling.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for modeling power used in a multi-tenant private cloud environment, the method comprising:
training an absolute power model to estimate absolute power in the multi-tenant private cloud environment;
training a dynamic power model to estimate dynamic power in the multi-tenant private cloud environment;
combining the absolute power model and the dynamic power model into a combined model; and
estimating power used in the multi-tenant private cloud environment using the combined model in response to error metrics of the combined model indicating that a measured error of the combined model is less than a threshold value.

2. The method as recited in claim 1 further comprising:
estimating power used by pods in a container orchestration system using the combined model in response to the error metrics of the combined model indicating that the measured error of the combined model is less than the threshold value.

3. The method as recited in claim 1, wherein the absolute power model comprises independent and dependent inferences, wherein the independent inferences comprise a cause of energy consumption corresponding to workload utilization regardless of environment, hardware and operating system, wherein the dependent inferences comprise other causes than the independent inferences.

4. The method as recited in claim 3 further comprising:
deconstructing the independent inferences of the absolute power model by removing a target workload utilization.

5. The method as recited in claim 4, wherein the dynamic power model comprises only the deconstructed independent inferences.

6. The method as recited in claim 5 further comprising:
validating the dynamic power model by reconstructing a dynamic workload with the dependent inferences.

7. The method as recited in claim 1 further comprising:
using error metrics of the dynamic power model together with correction and error metrics of the absolute power model to determine a goodness of the combined model.

8. A computer program product for modeling power used in a multi-tenant private cloud environment, the computer program product comprising one or more computer readable storage mediums having program code embodied therewith, the program code comprising programming instructions for:
training an absolute power model to estimate absolute power in the multi-tenant private cloud environment;
training a dynamic power model to estimate dynamic power in the multi-tenant private cloud environment;
combining the absolute power model and the dynamic power model into a combined model; and
estimating power used in the multi-tenant private cloud environment using the combined model in response to error metrics of the combined model indicating that a measured error of the combined model is less than a threshold value.

9. The computer program product as recited in claim 8, wherein the program code further comprises the programming instructions for:
estimating power used by pods in a container orchestration system using the combined model in response to the error metrics of the combined model indicating that the measured error of the combined model is less than the threshold value.

10. The computer program product as recited in claim 8, wherein the absolute power model comprises independent and dependent inferences, wherein the independent inferences comprise a cause of energy consumption corresponding to workload utilization regardless of environment, hardware and operating system, wherein the dependent inferences comprise other causes than the independent inferences.

11. The computer program product as recited in claim 10, wherein the program code further comprises the programming instructions for:
deconstructing the independent inferences of the absolute power model by removing a target workload utilization.

12. The computer program product as recited in claim 11, wherein the dynamic power model comprises only the deconstructed independent inferences.

13. The computer program product as recited in claim 12, wherein the program code further comprises the programming instructions for:
validating the dynamic power model by reconstructing a dynamic workload with the dependent inferences.

14. The computer program product as recited in claim 8, wherein the program code further comprises the programming instructions for:
using error metrics of the dynamic power model together with correction and error metrics of the absolute power model to determine a goodness of the combined model.

15. A system, comprising:
a memory for storing a computer program for modeling power used in a multi-tenant private cloud environment; and
a processor connected to the memory, wherein the processor is configured to execute program instructions of the computer program comprising:
training an absolute power model to estimate absolute power in the multi-tenant private cloud environment;
training a dynamic power model to estimate dynamic power in the multi-tenant private cloud environment;
combining the absolute power model and the dynamic power model into a combined model; and
estimating power used in the multi-tenant private cloud environment using the combined model in response to error metrics of the combined model indicating that a measured error of the combined model is less than a threshold value.

16. The system as recited in claim 15, wherein the program instructions of the computer program further comprise:
estimating power used by pods in a container orchestration system using the combined model in response to the error metrics of the combined model indicating that the measured error of the combined model is less than the threshold value.

17. The system as recited in claim 15, wherein the absolute power model comprises independent and dependent inferences, wherein the independent inferences comprise a cause of energy consumption corresponding to workload utilization regardless of environment, hardware and operating system, wherein the dependent inferences comprise other causes than the independent inferences.

18. The system as recited in claim 17, wherein the program instructions of the computer program further comprise:
deconstructing the independent inferences of the absolute power model by removing a target workload utilization.

19. The system as recited in claim 18, wherein the dynamic power model comprises only the deconstructed independent inferences.

20. The system as recited in claim 19, wherein the program instructions of the computer program further comprise:
validating the dynamic power model by reconstructing a dynamic workload with the dependent inferences.
